(19) United States
(12) Patent Application Publication
(10) Pub. No.: US 2001/0016014 A1
(43) Pub. Date: Aug. 23, 2001

(54) Communications system

(75) Inventor: Sueng-il Nam, New Malden (GB)

Correspondence Address: Jack E. Haken, U.S. Philips Corporation, 580 White Plains Road, Tarrytown, NY, 10591, US

(73) Assignee: U.S. PHILIPS CORPORATION

(21) Appl. No.: 09/773,417

(22) Filed: Feb. 1, 2001

(30) Foreign Application Priority Data
Feb. 23, 2000 (GB) 0004125.1

(51) Int. Cl. H04B 15/00; H04L 25/03; H04K 1/02; H04L 25/49

(52) U.S. Cl. 375/285; 375/296

(57) ABSTRACT

A short range communications system in which transmitted signals are distorted by multipath effects and non-linear characteristics of circuit elements and cause constellation errors in a received signal. These errors are determined by a receiving transceiver (TR′) which transmits a control signal to a transmitting transceiver (TR). The control signal is applied to a stage (12) to adjust the magnitude of input baseband data prior to modulation in a modulator (14) to predistort the constellation of the modulated signals in such a way that the distortion is effectively eliminated in propagation.

The present invention relates to a communications system, particularly but not exclusively, to short range communications operating in domestic and business environments in which a transmitted signal is distorted due to multipath effects.

It is known to combat multipath effects in various ways such as multilevel modulation, transmitter and receiver antenna diversity with beam forming techniques, and spread spectrum, and adaptive equalisation techniques.

WO99/33170 discloses a method of, and apparatus for, providing wideband predistortion linearisation in order to compensate for third order and higher order intermodulation distortion over a wideband. In implementing the method a modulated rf signal is predistorted prior to power amplification and propagation. The modulated rf signal is predistorted in a quadrature phase gain adjuster using a complex predistortion signal produced by a baseband polynominal predistortion circuit which makes use of coefficients produced by a controller. An error signal derived from the difference between a scaled output signal from the power amplifier and the input modulated rf signal is applied to the controller which generates complex control coefficients for use by the predisortion circuit, which also receives the input modulated rf signal. The predistortion signal generates the complex predistortion signal which is used in the quadrature phase gain adjuster to adjust the magnitude and phase of the input modulated rf signal. Additionally the controller generates constant complex coefficients which are added to the complex predistortion signal in order to correct the static portion of the difference between the rf power amplifier input and output. The arrangement disclosed operates on signals which are at rf frequencies and requires non-linear characteristics of hardware elements to be taken into account.

An object of the present invention is to predistort a signal to be transmitted so that the received signal after demodulation will show a substantially ideal constellation diagram.

According to one aspect of the present invention there is provided a method of operating a communications system in which the magnitude of an input baseband data stream to be modulated on a transmitter carrier frequency is varied to counter the effects of channel distortion on a constellation of a recovered symbol stream.

According to a second aspect of the present invention there is provided a communications system comprising modulating means for quadrature modulating a carrier with an input baseband data stream, means for combining and propagating the modulated signals, means for receiving the propagated signals and recovering the baseband data stream, means for determining if the constellation of the recovered signals has been distorted and for generating a control signal, and means responsive to the control signal for adjusting the magnitude of the input baseband data stream to predistort the modulated signals to minimise constellation errors in the recovered signals.

According to a third aspect of the present invention there is provided a communications system comprising first and second transceivers, the first transceiver comprising a transmitter section including a balanced direct carrier vector modulator having first inputs for quadrature related components of a carrier signal and complements of the quadrature related components and second inputs for quadrature related components of input data and complements of the quadrature related components of the input data, combining means for combining outputs of the balanced direct carrier vector modulator, signal propagation means coupled to said combining means, and means for adaptively adjusting the magnitude of the input data in response to control signals generated in and transmitted by the second transceiver, and the second transceiver having a receiving section including a demodulator for deriving quadrature baseband products of a received signal and a local oscillator signal and the complements thereof, decoding means for recovering data from an output of the demodulator, means for determining the presence of constellation errors in the demodulated signals and means for deriving a control signal in response to determining the presence of constellation errors, the second transceiver having means for transmitting the control signals to the first transceiver for use by said means for adaptively adjusting the magnitude of the input data to reduce the distorted constellation errors.

The method in accordance with the present invention not only effectively combats multipath in short range communications channels but also equalises non-linear distortion caused by non-linear hardware elements such as a high power, power amplifier (HPA). The HPA can be driven continuously at saturation because the method in accordance with the present invention can compensate for phase and amplitude errors caused by non-linear characteristics of the circuit. These improvements in performance will enable the communications systems to operate at a higher symbol rate with an improved bit error rate (BER).

In an embodiment of the present invention constellation errors can be detected by comparing two complementary channels, that is the in-phase channel I and its complement I′ and/or the quadrature channel Q and its complement Q′.

According to a fourth aspect of the present invention there is provided a transceiver having an input for data signals, means coupled to the input for adjusting the magnitude of the data signals in response to an external control signal, a balanced direct carrier vector modulator having a first input coupled to the data signal magnitude adjusting means, a second input for a carrier signal and an output for modulated signals, means for combining the modulated signals, signal propagation/receiving means coupled to said combining means and to a signal receiving means, demodulating means coupled to the signal receiving means, decoding means for recovering data signals in the demodulated signals, and means responsive to an external control signal indicating the presence of constellation errors in signals propagated by the propagating/receiving means, said control signal being applied to said means for adjusting the magnitude of the data signals, to predistort the data signals to be applied to the vector modulator.

The present invention will now be described, by way of example, with reference to the accompanying drawings, wherein:

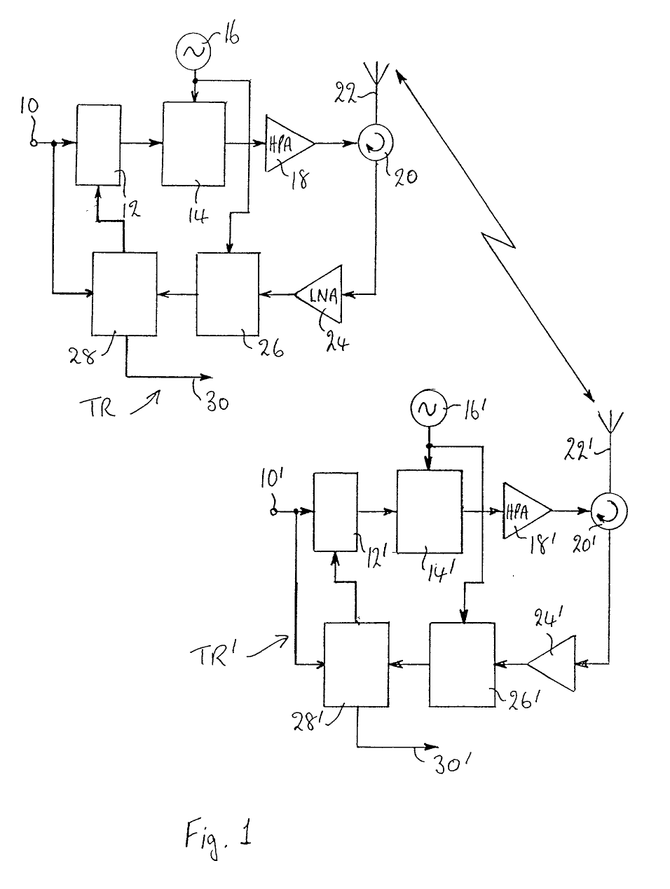

FIG. 1 is a block schematic diagram of a communications system made in accordance with the present invention,

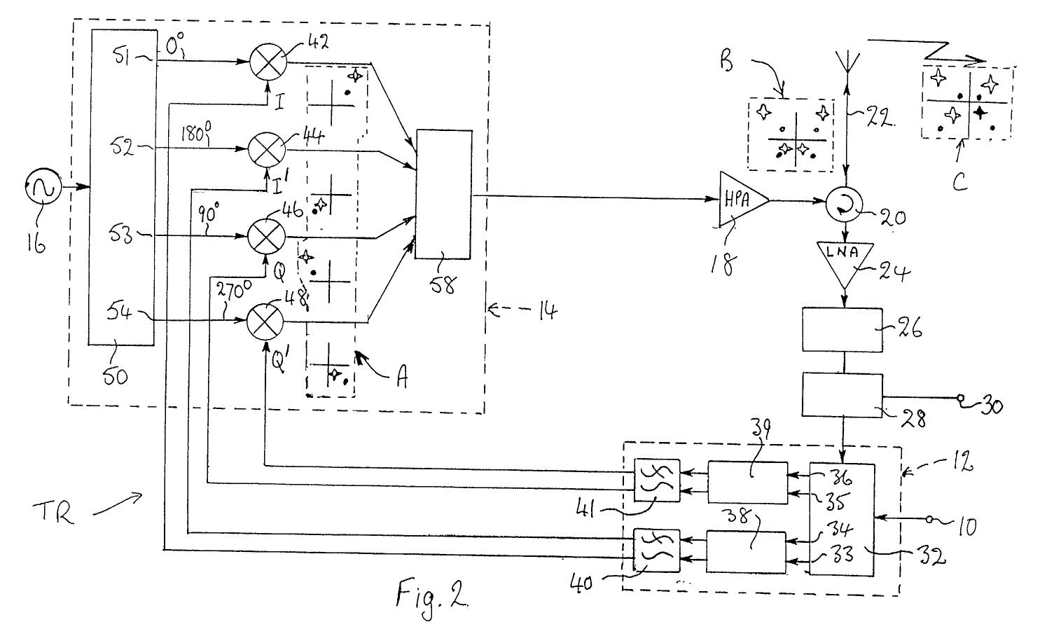

FIG. 2 is a block schematic diagram of a transceiver showing the transmitter section in greater detail, and

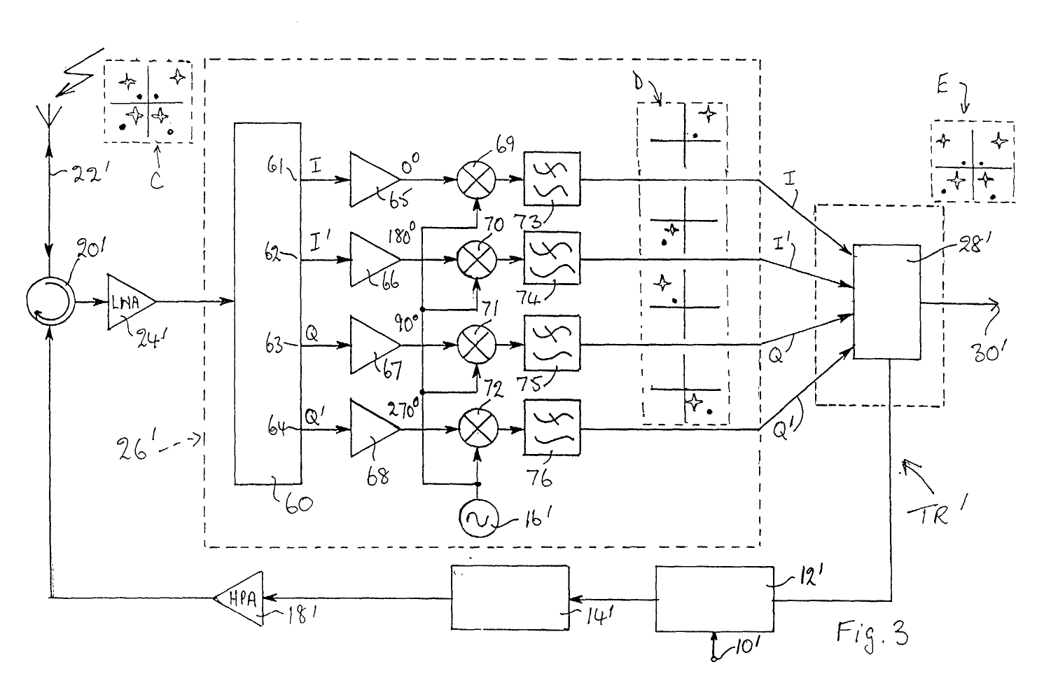

FIG. 3 is a block schematic diagram of a transceiver showing the receiver section in greater detail.

In the drawings the same reference numerals have been used to indicate corresponding features.

The communications system shown in FIG. 1 comprises two or more transceivers TR, TR′ which may be separate devices or integrated into a user equipment forming part of a short range, for example, domestic, local area network. Each of the transceivers TR, TR′ is of substantially the same architecture and in the interests of brevity the same reference numerals have been used but in the case of transceiver TR′ they are shown as primed reference numerals.

An input data stream is applied to a terminal 10 connected to a data predistorting stage 12 whose operation will be described in greater detail later and to a combined symbol timing recovery, decoder and feedback generator stage 28 to be described later. The predistorted data is supplied to a balanced direct carrier vector modulator 14 which is described in greater detail with reference to FIG. 2. A signal generator 16 provides a carrier frequency to the modulator 14 and a local oscillator frequency to a demodulator 26 which is described in greater detail with reference to FIG. 3. An output signal from the modulator 14 is supplied to high power amplifier (HPA) 18 in which the output signal is amplified before being applied to an antenna 22, by way of a circulator 20, for propagation to other transceivers in the LAN.

A signal received by the antenna 22′ of the transceiver TR′ is applied by way of the circulator 20′ to a low noise amplifier (LNA) 24′. An output of the LNA 24′ is coupled to a demodulator 26′, an output from which is applied to the symbol timing recovery (STR), decoder and feedback data generator stage 28′. Recovered data is present on an output terminal 30′. The stage 28′ also determines if the constellation of the received signals has been distorted by multipath effects and non-linearities in the hardware elements such as the HPA 18 of the transceiver TR. This stage 28′ generates data relating to the degree of distortion, which data is applied to a controller in the stage 12′ which generates a control signal stream which is transmitted to the transceiver TR. The signal received by the antenna 22 is demodulated and applied to the data predistorting stage 12 where it is used to vary the magnitude of the input data stream on the input 10 to predistort the constellation of the signals to be transmitted in such a manner as to overcome the effects of multipath and non-linearities thereby endeavouring that the constellation of the signals received is substantially ideal.

Referring now to FIGS. 2 and 3 which for convenience respectively show in greater detail the transmitting section of the transceiver TR and the receiving section of the transceiver TR′. However the complete architecture of both these transceivers is substantially the same. Referring initially to FIG. 2, the input data stream on the terminal 10 is applied to the data predistorting stage 12 which comprises a serial to parallel converter and controller stage 32 which provides quadrature related versions of the data I, Q and their complements I′, Q′ respectively on outputs 33, 35, 34, 36. The in-phase data signals I, I′ on the outputs 33, 34 are digitised in a digital to analogue converter (DAC) 38 and the outputs undergo baseband filtering in a low pass filter 40 before being applied as first inputs of multipliers 42, 44 of the balanced direct carrier vector modulator 14. The quadrature-phase signals Q, Q′ on the outputs 35, 36 are digitised and filtered in a DAC 39 and a low pass filter 41 and applied to first inputs of multipliers 46, 48, respectively of the modulator 14. The carrier signal generated by the signal generator 16 is applied to a quadrature phase splitter 50 which produces in-phase (0°) and quadrature phase (90°) versions of the carrier signal on outputs 51, 53, respectively, and their complements 180° and 270°, respectively, on outputs 52, 54. The outputs 51 to 54 are coupled to second inputs of the multipliers 42 to 48. The directly modulated products on the outputs of the multipliers 42 to 48 have the respective QPSK star constellations shown in the box marked A. The phase and amplitude of each constellation state are controlled by the magnitude of the respective data (or symbol) stream of the first inputs of the multipliers 42 to 48. These outputs are combined in an in-phase combiner 58 and its output is applied to the HPA 18 for amplification prior to propagation by the antenna 22. The constellation of the combined and amplified signals is shown by the box B and the constellation distorted as a result of multipath propagation is shown by the box C. In a multipath environment, the transmitted data stream experience the superposition of the direct path and its multipath echo.

Turning now to FIG. 3, the rf carrier signal with the distorted data (or symbol) stream received by the antenna 22′ is amplified in the LNA 24′ and applied to the decoder 26′ which includes a quadrature phase splitter 60 in which the signal is split into four phases 0°, 90°, 180° and 270° representing I, I′, Q and Q′, respectively, and are present on respective outputs 61 to 64. The respective signal phases are amplified in amplifiers 65 to 68 and applied to first inputs of respective multipliers 69 to 72. A local oscillator signal produced by the signal generator 16′ is applied to second inputs of the multipliers 69 to 72 in order to directly demodulate each channel. The recovered demodulated data on the output of each of the multipliers undergoes baseband filtering in respective low pass filters 73 to 76. The phase and amplitude of each demodulated signal is shown in the box D. The outputs of the filters 73 to 76 are applied to the symbol timing recovery (STR), decoder and feedback data generator stage 28′. This stage produces a recovered data stream on the output 30′. As shown in the box E, the constellation of the recovered data is distorted as a result of channel distortion.

Consequently a bit error may occur. Such an error can be detected by comparing the signals in two complementary channels, viz. I and I′ or Q and Q′, in the stage 28′. When an error is detected, the feedback data generator in the stage 28′ generates a control signal stream which is sent by way of the predistorting stage 12′, the modulator 14′, the HPA 18′ to the antenna 22′ from where it is transmitted to the transceiver, in this case the transceiver TR, from which the modulated signal was received.

Referring back to FIG. 2, the control signal stream is received by the antenna 22 and is demodulated in the demodulator 26. An output from the demodulator 26 is applied by way of the stage 28 to the data predistorting stage 12 to adaptively adjust the magnitude of the input data stream on the input 10. The adjusted baseband signal will be modulated as described above to form a deliberately distorted constellation to send through the multipath channel, which has been found empirically to be quasi-static in domestic and other indoor situations. At the receiving transceiver, the recovered data (or symbol) stream will have an ideal constellation or a constellation which is substantially ideal.

In a non-illustrated variant of the receiver architecture shown in FIG. 3, the output from the signal generator 16′ is applied to the quadrature phase splitter 60 and the data stream from the LNA 24′ is applied directly to the multiplier 69 to 72.

The described architecture reduces the complexity in communications applications because it does not require a complex chain of mixers, filters, amplifiers and IF signal processing. The architecture also provides efficient use of all non-linear circuit elements. For example, the high power amplifier (HPA) 18, 18′ can be driven at saturation all the time because the architecture can compensate for phase and amplitude errors caused by non-linear characteristics of the circuit. Furthermore, without any special coding techniques, the transceiver can detect errors by comparing two complementary channels (I and I′ or Q and Q′). Furthermore, when it is used with diversity and associated baseband coding techniques, the direct carrier equalisation technique will produce an improvement for wideband applications at microwave and millimetre-wave frequency band. In addition the modulation and demodulation can be done using passive components which do not consume power because of their passive circuit characteristics.

In the present specification and claims the word “a” or “an” preceding an element does not exclude the presence of a plurality of such elements. Further, the word “comprising” does not exclude the presence of other elements or steps than those listed.

From reading the present disclosure, other modifications will be apparent to persons skilled in the art. Such modifications may involve other features which are already known in the design, manufacture and use of short range communication systems and component parts therefor and which may be used instead of or in addition to features already described herein.

1. A method of operating a communications system in which the magnitude of an input baseband data stream to be modulated on a transmitter carrier frequency is varied to counter the effects of channel distortion on a constellation of a recovered symbol stream.

2. A method as claimed in claim 1, characterised by vector modulating quadrature related components of a carrier signal and complements of the quadrature related components of the carrier signal with quadrature related components of the input base band data stream and complements of the quadrature related components of the said data stream, combining the modulated signals, propagating the combined modulated signals, receiving the propagated signals, recovering the quadrature related components of a data stream and the complements of said quadrature related components, decoding the base band data from said recovered components, determining if there are distorted constellation errors and in response to determining that there are constellation errors generating a control signal including data relating to said constellation errors, and adaptively adjusting the magnitude of the input baseband data stream in response to said control signals to predistort the data stream in such a manner as to reduce the distorted constellation errors.

3. A method as claimed in claim 2, characterised in that the constellation errors are determined by comparing at least one complementary pair of the recovered signals.

4. A communications system comprising modulating means for quadrature modulating a carrier with an input baseband data stream, means for combining and propagating the modulated signals, means for receiving the propagated signals and recovering the baseband data stream, means for determining if the constellation of the recovered signals has been distorted and for generating a control signal, and means responsive to the control signal for adjusting the magnitude of the input baseband data stream to predistort the modulated signals to minimise constellation errors in the recovered signals.

5. A communications system comprising first and second transceivers, the first transceiver comprising a transmitter section including a balanced direct carrier vector modulator having first inputs for quadrature related components of a carrier signal and complements of the quadrature related components and second inputs for quadrature related components of input data and complements of the quadrature related components of the input data, combining means for combining outputs of the balanced direct carrier vector modulator, signal propagation means coupled to said combining means, and means for adaptively adjusting the magnitude of the input data in response to control signals generated in and transmitted by the second transceiver, and the second transceiver having a receiving section including a demodulator for deriving quadrature baseband products of a received signal and a local oscillator signal and the complements thereof, decoding means for recovering data from an output of the demodulator, means for determining the presence of constellation errors in the demodulated signals and means for deriving a control signal in response to determining the presence of constellation errors, the second transceiver having means for transmitting the control signals to the first transceiver for use by said means for adaptively adjusting the magnitude of the input data to reduce the distorted constellation errors.

6. A communications system as claimed in claim 5, characterised in that the means for determining the presence of constellation errors comprises means for comparing at least one complementary pair of demodulated signals.

7. A transceiver having an input for data signals, means coupled to the input for adjusting the magnitude of the data signals in response to an external control signal, a balanced direct carrier vector modulator having a first input coupled to the data signal magnitude adjusting means, a second input for a carrier signal and an output for modulated signals, means for combining the modulated signals, signal propagation/receiving means coupled to said combining means and to a signal receiving means, demodulating means coupled to the signal receiving means, decoding means for recovering data signals in the demodulated signals, and means responsive to an external control signal indicating the presence of constellation errors in signals propagated by the propagating/receiving means, said control signal being applied to said means for adjusting the magnitude of the data signals, to predistort the data signals to be applied to the vector modulator.

8. A transceiver as claimed in claim 7, characterised by means for determining the presence of constellation errors in demodulated signals, means responsive to determining the presence of constellation errors for deriving a control signal, said control signal being modulated on the carrier signal for propagation by the signal propagation/receiving means.

9. A transceiver as claimed in claim 8, characterised in that the signal receiving means comprises means for recovering quadrature related versions of the received signals and the complements thereof and in that the means for determining the presence of constellation errors compares one of the quadrature related versions and its complement.
